(19) United States
(12) Patent Application Publication
(10) Pub. No.: US 2014/0242385 A1
(43) Pub. Date: Aug. 28, 2014

(54) Liquid Crystalline Polymer Fibers

(71) Applicant: Ticona LLC, Florence, KY (US)

(72) Inventors: Kamlesh P. Nair, Florence, KY (US); Joseph J. Grenci, Florence, KY (US); Steven D. Gray, Mequon, WI (US)

(73) Assignee: Ticona LLC, Florence, KY (US)

(21) Appl. No.: 14/183,812

(22) Filed: Feb. 19, 2014

Related U.S. Application Data
(60) Provisional application No. 61/767,843, filed on Feb. 22, 2013.

(51) Int. Cl. C08G 63/672

(52) U.S. Cl. CPC C08G 63/672
USPC 428/401; 528/190; 264/211.12

(57) ABSTRACT

A fiber formed from a polymer composition that comprises a liquid crystalline polymer and an aromatic amide oligomer is provided. The present inventors have discovered that the oligomer can act as a flow aid for the polymer, which can provide a variety of different benefits. For example, the use of the oligomer during polymerization can lower the melt viscosity of the polymer as it is formed. This enables the formation of high molecular weight polymers that do not solidify within the reactor vessel. The formation of high molecular weight polymers during melt polymerization can, in turn, provide a variety of benefits, such as allowing for higher molecular weight polymers to be formed through additional processing (e.g., solid state polymerization) than conventionally possible, as well as enhancing the melt strength of the polymer composition and thereby aiding in the fiber formation process.

### RELATED APPLICATIONS

The present application claims priority to U.S. Provisional Application Ser. No. 61/767,843 (filed on Feb. 22, 2013) and which is incorporated herein in its entirety by reference thereto.

### BACKGROUND OF THE INVENTION

Thermotropic liquid crystalline polymers (“LCP”) are aromatic condensation polymers that have relatively rigid and linear polymer chains that can melt to form a liquid crystalline phase. Due to their highly inert behavior and excellent thermo-mechanical properties, liquid crystalline polymers are desirable for use in forming fibers for use in a wide variety of application. Unfortunately, it is difficult to spin fibers from many liquid crystalline polymer grades due to their relatively high molecular weight, and corresponding high melting temperature and high melt viscosity. Consequently, only liquid crystalline polymers with a relatively low molecular weight have traditionally used in fiber formation processes. In a typical process, for instance, a low molecular weight liquid crystalline polymer is initially spun into a fiber and then wound up on a roll. Because such low molecular weight fibers lack good strength properties, they are then subjected to a post-heat treatment step that initiates molecular chain extension and increases the molecular weight of the polymer. While this process can form fibers with improved strength, it is nevertheless problematic. For instance, the additional heat treatment processing step is time consuming and costly. Further, the relatively low melting temperature of the liquid crystalline polymer can prevent the resulting fibers from being used in high temperature applications.

As such, a need exists for an improved technique for forming liquid crystalline polymer fibers.

### SUMMARY OF THE INVENTION

In accordance with one embodiment, a fiber is disclosed that is formed from a polymer composition. The polymer composition comprises a thermotropic liquid crystalline polymer and an aromatic amide oligomer in an amount of from about 0.1 to about 8 parts by weight relative to 100 parts by weight of the liquid crystalline polymer.

In accordance with another embodiment of the present invention, a method for forming a fiber is disclosed that comprises extruding a polymer composition through a spinneret to form an elongate body and quenching the elongate body to form a fiber. The polymer composition comprises a thermotropic liquid crystalline polymer and an aromatic amide oligomer in an amount of from about 0.1 to about 8 parts by weight relative to 100 parts by weight of the liquid crystalline polymer.

Other features and aspects of the present invention are set forth in greater detail below.

### BRIEF DESCRIPTION OF THE FIGURE

A full and enabling disclosure of the present invention, including the best mode thereof, directed to one of ordinary skill in the art, is set forth more particularly in the remainder of the specification, which makes reference to the appended FIGURE in which:

FIG. 1 is a schematic illustration of a method for forming fibers in accordance with one embodiment of the present invention.

Repeat use of reference characters in the present specification and FIGURE is intended to represent same or analogous features or elements of the invention.

### DETAILED DESCRIPTION

### Definitions

It is to be understood that the terminology used herein is for the purpose of describing particular embodiments only and is not intended to limit the scope of the present invention.

“Alkyl” refers to monovalent saturated aliphatic hydrocarbyl groups having from 1 to 10 carbon atoms and, in some embodiments, from 1 to 6 carbon atoms. “C_{x-y}alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH₂CH₂), isobutyl ((CH₃)₂CHCH₂), sec-butyl ((CH₃)(CH₃CH₂)CH) butyl ((CH₃)₃C), n-pentyl (CH₃CH₂CH₂CH₂CH₂), and neopentyl ((CH₃)₃CCH₂).

“Alkenyl” refers to a linear or branched hydrocarbyl group having from 2 to 10 carbon atoms and in some embodiments from 2 to 6 carbon atoms or 2 to 4 carbon atoms and having at least 1 site of vinyl unsaturation (>C═C<). For example, (Cₓ—C_{y})alkenyl refers to alkenyl groups having from x to y carbon atoms and is meant to include for example, ethenyl, propenyl, 1,3-butadienyl, and so forth.

“Alkynyl” refers to refers to a linear or branched monovalent hydrocarbon radical containing at least one triple bond. The term “alkynyl” may also include those hydrocarbyl groups having other types of bonds, such as a double bond and a triple bond.

“Aryl” refers to an aromatic group of from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Cycloalkyl” refers to a saturated or partially saturated cyclic group of from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g., 5,6,7,8,-tetrahydronaphthalene-5-yl). The term “cycloalkyl” includes cycloalkenyl groups, such as adamantyl, cyclopropyl, cyclobutyl, cyclopentyl, cyclooctyl, and cyclohexenyl. The term “cycloalkenyl” is sometimes employed to refer to a partially saturated cycloalkyl ring having at least one site of >C═C< ring unsaturation.

“Halo” or “halogen” refers to fluoro, chloro, bromo, and iodo.

“Haloalkyl” refers to substitution of alkyl groups with 1 to 5 or in some embodiments 1 to 3 halo groups.

“Heteroaryl” refers to an aromatic group of from 1 to 14 carbon atoms and 1 to 6 heteroatoms selected from oxygen, nitrogen, and sulfur and includes single ring (e.g., imidazolyl) and multiple ring systems (e.g., benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g., 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g., decahydroquinolin-6-yl). In some embodiments, the nitrogen and/or sulfur atom(s) of the heterocyclic group are optionally oxidized to provide for the N oxide, sulfinyl, sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned groups encompass unsubstituted groups, as well as groups substituted with one or more other functional groups as is known in the art. For example, an alkynyl, alkyl, alkenyl, aryl, heteroaryl, cycloalkyl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents.

“Liquid Crystalline Polymer” refers to a polymer that can possess a rod-like structure that allows it to exhibit liquid crystalline behavior in its molten state (e.g., thermotropic nematic state). The polymer may contain aromatic units (e.g., aromatic polyesters, aromatic polyesteramides, etc.) so that it is wholly aromatic (e.g., containing only aromatic units) or partially aromatic (e.g., containing aromatic units and other units, such as cycloaliphatic units). The polymer may also be fully crystalline or semi-crystalline in nature.

“Fiber” refers to an elongate body in which the length dimension of is substantially greater than the transverse dimension. The cross-section of a fiber may vary widely, such as circular, flat or oblong in cross-section. Fibers may be in the form of individual staple fibers or filaments (continuous fibers), yarns, threads, strands, wires, ribbons, fabrics, etc. Yarns may include, for instance, multiple staple fibers that are braided or twisted together (“spun yarn”), filaments laid together without twist (“zero-twist yarn”), (3) filaments laid together with a degree of twist, (4) a single filament with or without twist (“monofilament”), etc. The yarn may or may not be texturized. When multiple fibers are employed, such as in a bundle or yarn, any number of fibers can be used, such as from about 10 to about 800, and in some embodiments, from about 50 to about 500.

### DESCRIPTION

It is to be understood by one of ordinary skill in the art that the present discussion is a description of exemplary embodiments only, and is not intended as limiting the broader aspects of the present invention.

Generally speaking, the present invention is directed to a fiber that is formed from a polymer composition that comprises a liquid crystalline polymer and an aromatic amide oligomer. The present inventors have discovered that the oligomer can act as a flow aid for the polymer, which can provide a variety of different benefits. For example, the use of the oligomer during polymerization can lower the melt viscosity of the polymer as it is formed. This enables the formation of high molecular weight polymers that do not solidify within the reactor vessel. The formation of high molecular weight polymers during melt polymerization can, in turn, provide a variety of benefits, such as allowing for higher molecular weight polymers to be formed through additional processing (e.g., solid state polymerization) than conventionally possible, as well as enhancing the melt strength of the polymer composition and thereby aiding in the fiber formation process. Another benefit of the oligomer is that it is not easily volatized or decomposed, which allows it to be processed at relatively high temperatures. Without intending to be limited by theory, it is believed that active hydrogen atoms of the amide functional groups are capable of forming a hydrogen bond with the backbone of the liquid crystalline polymer, which strengthens the attachment of the oligomer to the liquid crystalline polymer and thus minimizes the likelihood that it becomes volatilized. While providing the benefits noted, the aromatic amide oligomer does not generally react with the polymer backbone of the liquid crystalline polymer to any appreciable extent so that the mechanical properties of the polymer are not adversely impacted.

The relative amount of the aromatic amide oligomer may be selected to help achieve a balance between viscosity and mechanical properties. In most embodiments, for example, the aromatic amide oligomer, or mixtures thereof, may be employed in an amount of from about 0.1 to about 8 parts, in some embodiments from about 0.5 to about 5 parts, and in some embodiments, from about 1 to about 4 parts by weight relative to 100 parts by weight of the liquid crystalline polymer. Aromatic amide oligomers may, for example, constitute from about 0.1 wt. % to about 8 wt. %, in some embodiments from about 0.5 wt. % to about 5 wt. %, and in some embodiments, from about 1 wt. % to about 4 wt. % of the reaction mixture. Liquid crystalline polymers may likewise constitute from about 92 wt. % to about 99.9 wt. %, in some embodiments from about 95 wt. % to about 99.5 wt. %, and in some embodiments, from about 96 wt. % to about 99 wt. % of the polymer composition.

Various embodiments of the present invention will now be described in more detail.

### I. Polymer Composition

A. Aromatic Amide Oligomer

The aromatic amide oligomer generally has a relatively low molecular weight. For example, the oligomer typically has a molecular weight of about 1,000 grams per mole or less, in some embodiments from about 50 to about 750 grams per mole, in some embodiments from about 100 to about 600 grams per mole, and in some embodiments, from about 150 to about 500 grams per mole. In addition to possessing a relatively low molecular weight, the oligomer also generally possesses a high amide functionality so it is capable of undergoing a sufficient degree of hydrogen bonding with the liquid crystalline polymer. The degree of amide functionality for a given molecule may be characterized by its “amide equivalent weight”, which reflects the amount of a compound that contains one molecule of an amide functional group and may be calculated by dividing the molecular weight of the compound by the number of amide groups in the molecule. For example, the aromatic amide oligomer may contain from 1 to 10, in some embodiments from 2 to 8, and in some embodiments, from 2 to 4 amide functional groups per molecule. The amide equivalent weight may likewise be from about 10 to about 1,000 grams per mole or less, in some embodiments from about 50 to about 500 grams per mole, and in some embodiments, from about 100 to about 300 grams per mole.

As indicated above, it is desirable that the amide oligomer is also generally unreactive so that it does not form covalent bonds with the liquid crystalline polymer backbone. To help better minimize reactivity, the oligomer typically contains a core formed from one or more aromatic rings (including heteroaromatic). The oligomer may also contain terminal groups formed from one or more aromatic rings and/or cycloalkyl groups. Such an “aromatic” oligomer thus possesses little, if any, reactivity with the base liquid crystalline polymer. In one embodiment, for example, the aromatic amide oligomer may have the following general formula (I):

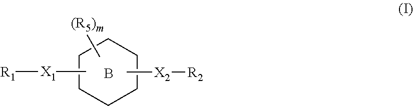

wherein,

ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;

R₅ is halo, haloalkyl, alkyl, alkenyl, aryl, heteroaryl, cycloalkyl, or heterocyclyl;

m is from 0 to 4;

X₁ and X₂ are independently C(O)HN or NHC(O); and

R₁ and R₂ are independently selected from aryl, heteroaryl, cycloalkyl, and heterocyclyl.

In certain embodiments, Ring B in Formula (I) above may be selected from the following:

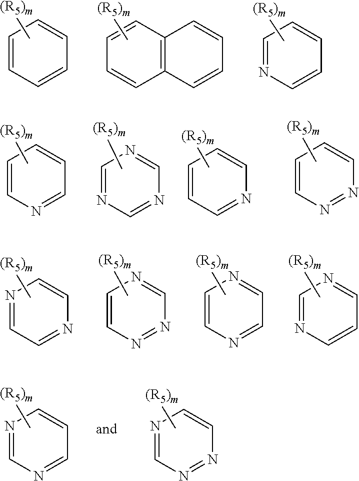

wherein,

m is 0, 1, 2, 3, or 4, in some embodiments m is 0, 1, or 2, in some embodiments m is 0 or 1, and in some embodiments, m is 0; and

R₅ is halo, haloalkyl, alkyl, alkenyl, aryl, heteroaryl, cycloalkyl, or heterocyclyl. Ring B may be phenyl.

The oligomer may be a di-functional compound in that Ring B is directly bonded to only two (2) amide groups (e.g., C(O)HN or NHC(O)). In such embodiments, m in Formula (I) may be 0. Of course, in certain embodiments, Ring B may also be directly bonded to three (3) or more amide groups. For example, one embodiment of such a compound is provided by general formula (II):

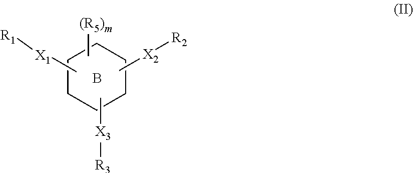

wherein,

ring B, R₅, X₁, X₂, R₁, and R₂ are as defined above;

m is from 0 to 3;

X₃ is C(O)HN or NHC(O); and

R₃ is selected from aryl, heteroaryl, cycloalkyl, and heterocyclyl.

Another embodiment of such a compound is provided by general formula (III):

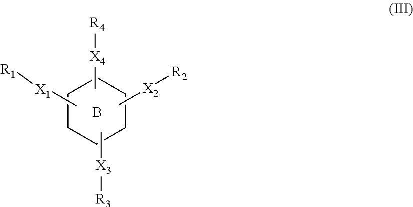

wherein,

ring B, R₅, X₁, X₂, X₃, R₁, R₂, and R₃ are as defined above;

X₄ is C(O)HN or NHC(O); and

R₄ is selected from aryl, heteroaryl, cycloalkyl, and heterocyclyl,

In some embodiments, R₁, R₂, R₃ and/or R₄ in the structures noted above may be selected from the following:

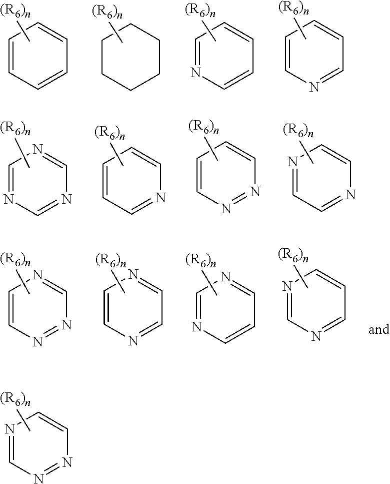

wherein,

n is 0, 1, 2, 3, 4, or 5, in some embodiments n is 0, 1, or 2, and in some embodiments, n is 0 or 1; and

R₆ is halo, haloalkyl, alkyl, alkenyl, alkynyl, aryl, heteroaryl, cycloalkyl, or heterocyclyl.

In one particular embodiment, the aromatic amide oligomer has the following general formula (IV):

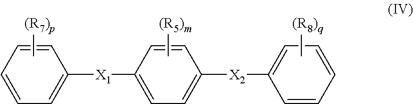

wherein,

X₁ and X₂ are independently C(O)HN or NHC(O);

R₅, R₇, and R₈ are independently selected from halo, haloalkyl, alkyl, alkenyl, alkynyl, aryl, heteroaryl, cycloalkyl, and heterocyclyl;

m is from 0 to 4; and

p and q are independently from 0 to 5.

In another embodiment, the aromatic amide oligomer has the following general formula (V):

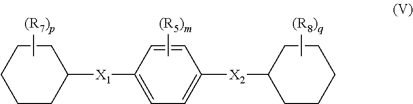

wherein,

X₁, X₂, R₈, R₇, R₈, m, p, and q are as defined above.

For example, in certain embodiments, m, p, and q in Formula (IV) and Formula (V) may be equal to 0 so that the core and terminal aromatic groups are unsubstituted. In other embodiments, m may be 0 and p and q may be from 1 to 5. In such embodiments, for example, R₇ and/or R₈ may be halo (e.g., fluorine), In other embodiments, R₇ and/or R₈ may be aryl (e.g., phenyl), cycloalkyl (e.g., coclyhexyl), or aryl and/or cycloalkyl substituted with an amide group having the structure: —C(O)R₁₂N— or —NR₁₃C(O)—, wherein R₁₂ and R₁₃ are independently selected from hydrogen, alkyl, alkenyl, alkynyl, aryl, heteroaryl, cycloalkyl, and heterocyclyl. In one particular embodiment, for example, R₇ and/or R₈ are phenyl substituted with —C(O)HN— or —NHC(O)—. In yet other embodiments. R₇ and/or R₈ may be heteroaryl (e.g., pyridinyl).

In yet another embodiment, the aromatic amide oligomer has the following general formula (VI):

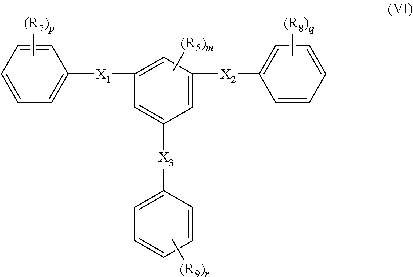

wherein,

X₁, X₂, and X₃ are independently C(O)HN or NHC(O);

R₅, R₇, R₈, and R₉ are independently selected from halo, haloalkyl, alkyl, alkenyl, alkynyl, aryl, heteroaryl, cycloalkyl, and heterocyclyl;

m is from 0 to 3; and

p, q, and r are independently from 0 to 5.

In yet another embodiment, the aromaticamide oligomer has the following general formula (VII):

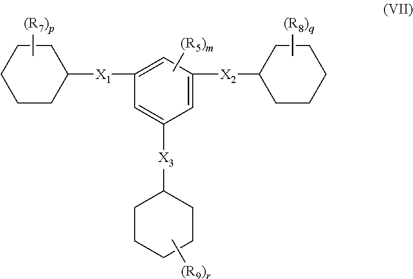

wherein,

X₁, X₂, X₃, R₅, R₇, R₈, R₉, m, p, q, and r are as defined above.

For example, in certain embodiments, m, p, q, and r in Formula (VI) or in Formula (VII) may be equal to 0 so that the core and terminal aromatic groups are unsubstituted. In other embodiments, m may be 0 and p, q, and r may be from 1 to 5. In such embodiments, for example, R₇, R₈, and/or R₉ may be halo (e.g., fluorine). In other embodiments, R₇, R₈, and/or Ry may be aryl (e.g., phenyl), cycloalkyl (e.g., cyclohexyl), or aryl and/or cycloalkyl substituted with an amide group having the structure: —C(O)R₁₂N— or —NR₁₃C(O)—, wherein R₁₂ and R₁₃ are independently selected from hydrogen, alkyl, alkenyl, alkynyl, aryl, heteroaryl, cycloalkyl, and heterocyclyl. In one particular embodiment, for example, R₇, R₉, and/or R₉ are phenyl substituted with —C(O)HN— or —NHC(O)—. In yet other embodiments, R₇, R₈, and/or R₉ may be heteroaryl (e.g., pyridinyl).

Specific embodiments of the aromatic amide oligomer of the present invention are also set forth in the table below:

| CMpd | | | MW |
|---|---|---|---|
| # | Structure | Name | (g/mol) |
| A | 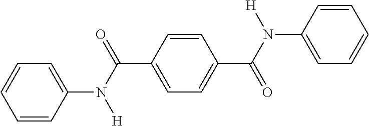 [SMILES: O=C(Nc1ccccc1)c1ccc(C(=O)Nc2ccccc2)cc1] | N1,N4-diphenylterephthalamide | 316.4 |
| B | 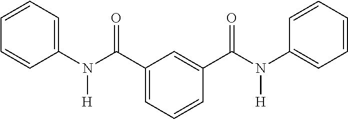 [SMILES: O=C(Nc1ccccc1)c1cccc(C(=O)Nc2ccccc2)c1] | N1,N4-diphenylisophthalamide | 316.4 |
| C | 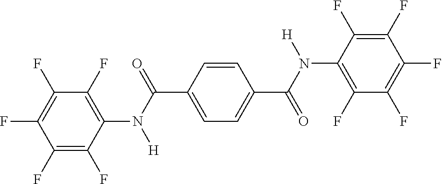 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl)- terephthalamide | 496.3 |
| D | 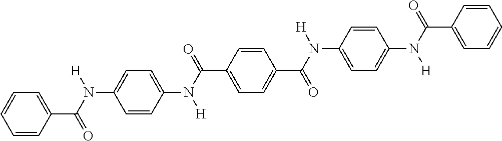 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzamidophenyl)terephthalamide | 554.6 |
| E | 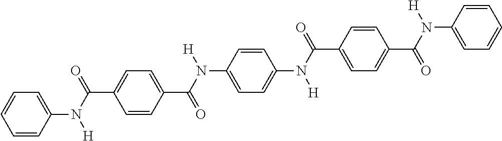 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1-[4-[[4- (phenylcarbamoyl)benzoyl]amino] phenyl] terephthalamide | 554.6 |
| F1 | 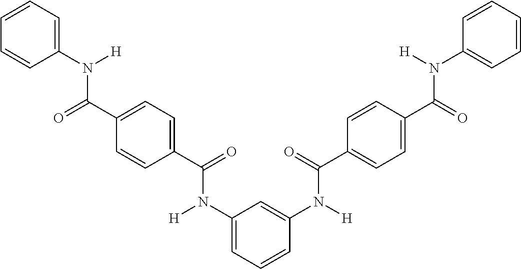 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl)benzoyl]amino] phenyl] terephthalamide | 554.6 |
| F2 | 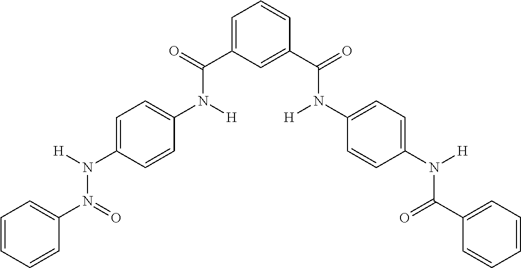 | N1,N3-bis(4- benzamidophenyl)benzene-1,3- dicarboxamide | 554.6 |
| G1 | 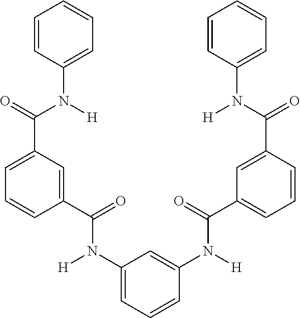 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl)benzoyl]amino] phenyl] benzene-1,3-dicarboxamide | 554.6 |
| G2 | 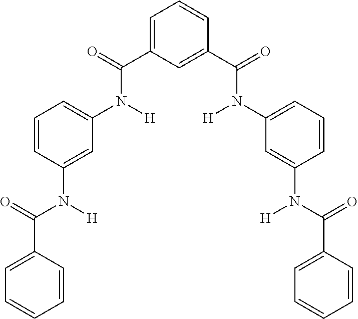 [SMILES: O=C(Nc1cccc(NC(=O)c2cccc(C(=O)Nc3cccc(NC(=O)c4ccccc4)c3)c2)c1)c1ccccc1] | N1,N3-bis(3- benzamidophenyl)benzene-1,3- dicarboxamide | 554.6 |
| H | 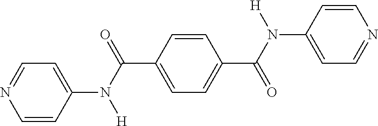 [SMILES: O=C(Nc1ccncc1)c1ccc(C(=O)Nc2ccncc2)cc1] | N1,N4-bis(4- pyridyl)terephthalamide | 318.3 |
| I | 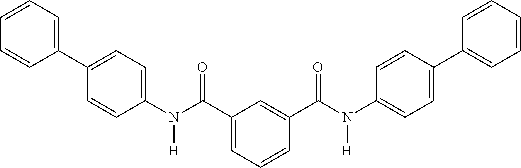 [SMILES: O=C(Nc1ccc(-c2ccccc2)cc1)c1cccc(C(=O)Nc2ccc(-c3ccccc3)cc2)c1] | N1,N3-bis(4- phenylphenyl)benzene-1,3- dicarboxamide | 468.5 |
| J | 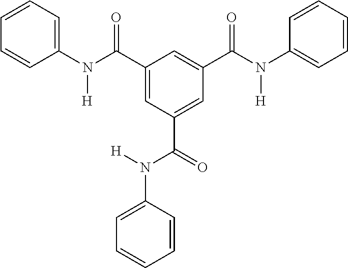 [SMILES: O=C(Nc1ccccc1)c1cc(C(=O)Nc2ccccc2)cc(C(=O)Nc2ccccc2)c1] | N1,N3,N5-triphenylbenzene-1,3,5- tricarboxamide | 435.5 |
| K | 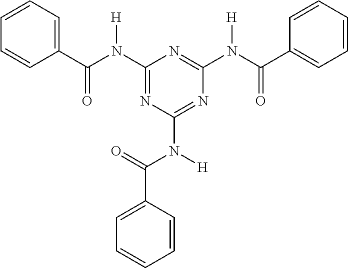 [SMILES: O=C(Nc1nc(NC(=O)c2ccccc2)nc(NC(=O)c2ccccc2)n1)c1ccccc1] | N-(4,6-dibenzamido-1,3,5-triazin- 2-yl)benzamide | 438.4 |
| L1 | 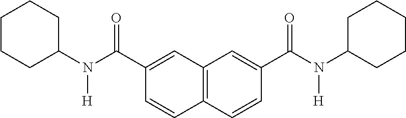 [SMILES: O=C(NC1CCCCC1)c1ccc2ccc(C(=O)NC3CCCCC3)cc2c1] | N2,N7-dicyclohexylnaphthalene- 2,7-dicarboxamide | 378.5 |
| L2 | 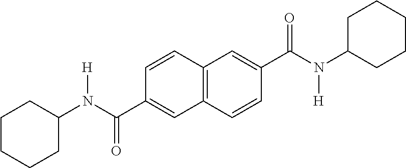 [SMILES: O=C(NC1CCCCC1)c1ccc2cc(C(=O)NC3CCCCC3)ccc2c1] | N2,N6-dicyclohexylnaphthalene- 2,6-dicarboxamide | 378.5 |
| N1 | 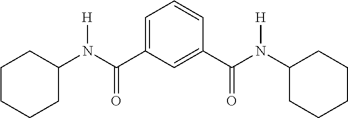 [SMILES: O=C(NC1CCCCC1)c1cccc(C(=O)NC2CCCCC2)c1] | N1,N3-dicyclohexyl-1,3- Benzenedicarboxamide | 328.5 |
| N2 | 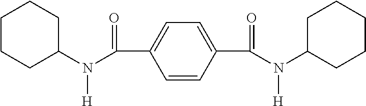 [SMILES: O=C(NC1CCCCC1)c1ccc(C(=O)NC2CCCCC2)cc1] | N1,N4-dicyclohexyl-1,4- Benzenedicarboxamide | 328.5 |
| O | 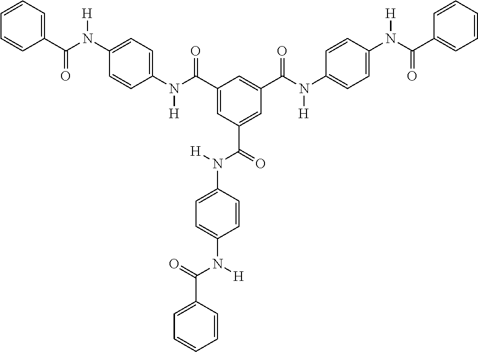 [SMILES: O=C(Nc1ccc(NC(=O)c2cc(C(=O)Nc3ccc(NC(=O)c4ccccc4)cc3)cc(C(=O)Nc3ccc(NC(=O)c4ccccc4)cc3)c2)cc1)c1ccccc1] | N1,N3,N5-tris(4- benzamidophenyl)benzene-1,3,5- tricarboxamide | 792.8 |
| P | 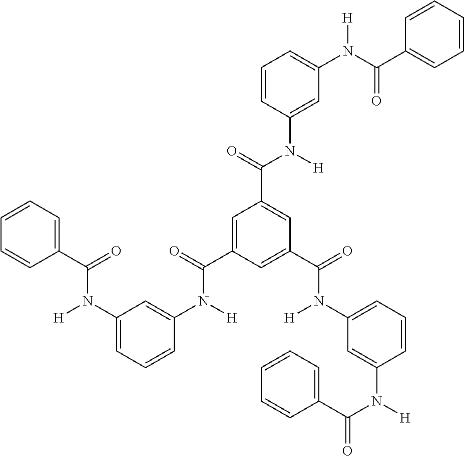 [SMILES: O=C(Nc1cccc(NC(=O)c2cc(C(=O)Nc3cccc(NC(=O)c4ccccc4)c3)cc(C(=O)Nc3cccc(NC(=O)c4ccccc4)c3)c2)c1)c1ccccc1] | N1,N3,N5-tris(3- benzamidophenyl)benzene-1,3,5- tricarboxamide | 792.8 |

B. Liquid Crystalline Polymer

Liquid crystalline polymers are generally classified as “thermotropic” to the extent that they can possess a rod-like structure and exhibit a crystalline behavior in their molten state (e.g., thermotropic nematic state). Such polymers may be formed from one or more types of repeating units as is known in the art. The liquid crystalline polymer may, for example, contain one or more aromatic ester repeating units, typically in an amount of from about 60 mol. % to about 99.9 mol. %, in some embodiments from about 70 mol. % to about 99.5 mol. %, and in some embodiments, from about 80 mol. % to about 99 mol. % of the polymer. The aromatic ester repeating units may be generally represented by the following Formula (VIII):

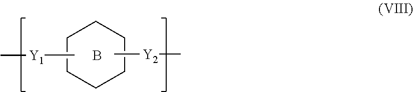

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O), wherein at least one of Y₁ and Y₂ are C(O).

Examples of aromatic ester repeating units that are suitable for use in the present invention may include, for instance, aromatic dicarboxylic repeating units (Y₁ and Y₂ in Formula VIII are C(O)), aromatic hydroxycarboxylic repeating units (Y₁ is O and Y₂ is C(O) in Formula VIII), as well as various combinations thereof,

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 0.5 mol. % to about 50 mol. %, in some embodiments from about 1 mol. % to about 30 mol. %, and in some embodiments, from about 5 mol. % to about 20% of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 20 mol. % to about 85 mol. %, in some embodiments from about 40 mol. % to about 80 mol. %, and in some embodiments, from about 50 mol. % to about 75% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 35 mol. %, in some embodiments from about 2 mol. % to about 30 mol. %, and in some embodiments, from about 5 mol. % to about 25% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, dials, amides, amines, etc. Of course, in other embodiments, the polymer may be “wholly aromatic” in that it lacks repeating units derived from non-aromatic (e.g., aliphatic or cycloaliphatic) monomers.

In certain embodiments, the liquid crystalline polymer may be a “low naphthenic” polymer to the extent that it contains a minimal content of repeating units derived from naphthenic hydroxycarboxylic acids and naphthenic dicarboxylic acids, such as naphthalene-2,6-dicarboxylic acid (“NBA”), 6-hydroxy-2-naphthoic acid (“HNA”), or combinations thereof. That is, the total amount of repeating units derived from naphthenic hydroxycarboxylic and/or dicarboxylic acids (e.g., NBA, HNA, or a combination of HNA and NDA) is typically no more than 15 mol. %, in some embodiments no more than about 13 mol. %, in some embodiments no more than about 10 mol. %, in some embodiments no more than about 8 mol. %, and in some embodiments, from 0 mol. % to about 5 mol. % of the polymer (e.g., 0 mol. %). In one particular embodiment, for example, a “low naphthenic” aromatic polyester may be formed that contains monomer repeat units derived from 4-hydroxybenzoic acid (“NBA”), terephthalic acid (“TA”) and/or isophthalic acid (“IA”); as well as various other optional constituents. The monomer units derived from 4-hydroxybenzoic acid (“HBA”) may constitute from about 40 mol. % to about 95 mol. %, in some embodiments from about 45 mol. % to about 90 mol. %, and in some embodiments, from about 50 mol. % to about 80 mol. % of the polymer, while the monomer units derived from terephthalic acid (“TA”) and/or isophthalic acid (“IA”) may each constitute from about 1 mol. % to about 30 mol. %, in some embodiments from about 2 mol. % to about 25 mol. %, and in some embodiments, from about 5 mol. % to about 20 mol. % of the polymer. Other possible monomer repeat units include aromatic dials, such as 4,4′-biphenol (“BP”), hydroquinone (“HQ”), etc. and aromatic amides, such as acetaminophen (“APAP”). In certain embodiments, for example, BP, HQ, and/or APAP may each constitute from about 1 mol. % to about 30 mol. %, in some embodiments from about 2 mol. % to about 25 mol. %, and in some embodiments, from about 3 mol. % to about 20 mol. % when employed. If desired, the polymer may also contain a small amount of 6-hydroxy-2-naphthoic acid (“HNA”) within the ranges noted above,

Although not necessarily required, the liquid crystalline polymer may be formed by melt polymerizing two or more precursor monomers (e.g., acetylated or non-acetylated), such as described above, in the presence of the aromatic amide oligomer. This may be accomplished by initially introducing the aromatic monomer(s) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

As indicated above, the aromatic amide oligomer may be added to the polymerization apparatus. Although it may be introduced at any time, it is typically desired to apply the oligomer before melt polymerization has been initiated, and typically in conjunction with the precursor monomers for the liquid crystalline polymer. In most embodiments, the aromatic amide oligomer, or mixtures thereof, may be employed in an amount of from about 0.1 to about 8 parts, in some embodiments from about 0.5 to about 5 parts, and in some embodiments, from about 1 to about 4 parts by weight relative to 100 parts by weight of the reaction mixture. The aromatic amide oligomers may, for example, constitute from about 0.1 wt. % to about 8 wt. %, in some embodiments from about 0.5 wt. % to about 5 wt. %, and in some embodiments, from about 1 wt. % to about 4 wt. % of the reaction mixture. Liquid crystalline polymers may likewise constitute from about 92 wt. % to about 99.9 wt. %, in some embodiments from about 95 wt. % to about 99.5 wt. %, and in some embodiments, from about 96 wt. % to about 99 wt. % of the reaction mixture.

In addition to the monomers, oligomer, and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 225° C. to about 400° C. For instance, one suitable technique for forming the liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 225° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 250° C. to about 350° C. The polymerization time will of course vary based on the temperature and target molecular weight. In most cases, however, the solid-state polymerization time will be from about 2 to about 12 hours, and in some embodiments, from about 4 to about 10 hours.

In addition to or in lieu of being supplied during synthesis, it is also possible to combine the aromatic amide oligomer with a liquid crystalline polymer after it is formed. For instance, the polymer and aromatic amide oligomer may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the liquid crystalline polymer and oligomer may be fed to the same or different feeding ports of a twin-screw extruder and melt blended to form a substantially homogeneous melted mixture. Melt blending or processing may occur under high shear/pressure and heat to ensure sufficient mixing. For example, melt processing may occur at a temperature of from about 200° C. to about 450° C., in some embodiments from about 220° C. to about 400° C., and in some embodiments, from about 250° C. to about 350° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

In addition to the components identified above, various other additives may also be incorporated in the polymer composition if desired. For example, a filler material may be incorporated into the polymer composition to enhance strength. Still other additives that can be included in the composition may include, for instance, antimicrobials, fillers, pigments, antioxidants, stabilizers, surfactants, waxes, solid solvents, and other materials added to enhance properties and processability.

Regardless of the particular method employed, the resulting liquid crystalline polymer composition may have a high number average molecular weight (Mₙ) of about 2,000 grams per mole or more, in some embodiments from about 4,000 grams per mole or more, and in some embodiments, from about 5,000 to about 30,000 grams per mole. The intrinsic viscosity of the polymer composition, which is generally proportional to molecular weight, may also be relatively high. For example, the intrinsic viscosity may be about 4 deciliters per gram (“dL/g”) or more, in some embodiments about 5 dL/g or more, in some embodiments from about 6 to about 20 dL/g, and in some embodiments from about 7 to about 15 dL/g. Intrinsic viscosity may be determined in accordance with ISO-1628-5 using a 50/50 (v/v) mixture of pentafluorophenol and hexafluoroisopropanol, as described in more detail below. The resulting polymer composition may also have a relatively high melting temperature. For example, the melting temperature may range from about 250° C. to about 400° C., in some embodiments from about 260° C. to about 390° C., and in some embodiments, from about 270° C. to about 380° C. Likewise, the crystallization temperature may range from about 200° C. to about 300° C., in some embodiments from about 220° C. to about 290° C., and in some embodiments, from about 240° C. to about 280° C. The melting and crystallization temperatures may be determined as is well known in the art using differential scanning calorimetry (“DSC”), such as determined by ISO Test No. 11357.

The melt viscosity of the polymer composition may likewise be about 50 Pa-s or more, in some embodiments from about 60 to about 800 Pa-s, and in some embodiments, from about 80 to about 700 Pa-s, determined at a shear rate of 1000 seconds⁻¹. Melt viscosity may be determined in accordance with ASTM Test No. 1238-70 at temperatures ranging from 280° C. to 370° C. depending on the melting temperature (e.g., 340° C., 345° C., or 350° C.). For example, melt viscosity may be determined at a temperature of about 10° C. above the melting temperature.

### II. Fibers

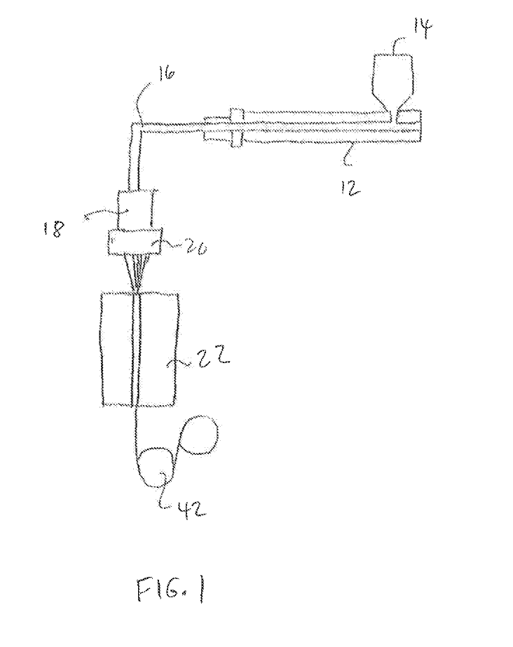

Any of a variety of processes may be employed in the present invention to form fibers from the polymer composition, such as solution spinning, melt spinning, etc. For example, the composition may be extruded through a spinneret, quenched, and optionally drawn into the vertical passage of a fiber draw unit. Referring to FIG. 1, for instance, the polymer composition may be fed into an extruder 12 from a hopper 14. The extruder (e.g., single or twin screw) may include a screw rotatably mounted and received within a barrel (e.g., cylindrical barrel), which may be heated. The composition may be moved downstream from a feed end to a discharge end by forces exerted by rotation of the screw. The speed of the screw may be selected to help achieve the desired residence time, shear rate, melt processing temperature, etc. The extruder may employ one or multiple zones, at least one of which operates at a temperature in the range of about 20° C. to about 50° C. above the melting temperature of the polymer, such as at a temperature of from about 350° C. to about 450° C. From the extruder 12, the polymer composition may be supplied in a molten state to a spinneret 18 through a polymer conduit 16. Spinnerets for extruding fibers are well known to those of skill in the art. For example, the spinneret 18 may include a housing containing a spin pack having a filter and/or breaker plates stacked one on top of each other and having a pattern of openings arranged to create flow paths for directing polymer components. The spinneret 18 also has at least one orifice, such a pattern of orifices arranged in one or more rows. The orifice can shape the polymer composition into an elongate body (or bodies) as it therethrough.

If desired, the fibers exiting the spinneret 18 may enter into a shroud 20 that is positioned adjacent thereto. The shroud 20 may be heated so that the fibers do not solidly immediately after exiting the spinneret 18. For example, the temperature of the fibers within the shroud 20 may be maintained at a temperature that is between the crystallization temperature and the temperature of the polymer within the spinneret 18. Minimizing the degree of solidification after spinning may allow for the fibers to be more readily drawn. In this regard, a fiber draw unit or aspirator 22 may be optionally positioned below the spinneret 18 and optional shroud 20 to draw the fibers before they are quenched. Fiber draw units for use in melt spinning polymers are well-known in the art. For example, the fiber draw unit 22 may include an elongate vertical passage through which the fibers are drawn by aspirating air entering from the sides of the passage and flowing downwardly through the passage. A heater or blower may supply aspirating air to the fiber draw unit 22. The aspirating air draws the filaments and ambient air through the fiber draw unit 22. The draw-down ratio may be selectively controlled in the present invention to achieve fibers having the desired properties. More particularly, the draw-down ratio is typically selected within a range of from about 2 to about 60, and in some embodiments, from about 10 to about 35. This ratio is often expressed as the ratio of the take-up speed of the fiber (V₂) to the extrusion speed of the fiber (V₁). Thus the draw-down ratio may be expressed in terms of the following equation:

Draw Down Ratio=V₂/V₁

The resulting fibers may be collected on godet rolls 42. The fibers may also be subjected to optional in line processing and/or converting steps (not shown) as will be understood by those skilled in the art. Unlike conventional processes for forming liquid crystalline polymer fibers, however, fibers may be formed in accordance with the present invention without the need for an additional heat treatment step after the fibers are quenched. Nevertheless, in certain embodiments, such additional heat treatment can optionally be employed. For example, in certain embodiments, the fibers may be thermally treated at a temperature that is about 10° C. to about 30° C. below the melting temperature of the liquid crystalline polymer, at which temperature the fibers remains in a solid state. The heat treatment may, for example, occur at a temperature of from about 320° C. to about 370° C. Although not necessarily required, the heat treatment typically occurs in the presence of an inert gas, such as nitrogen, argon, helium, etc.

Once formed, the resulting fibers may have an average diameter in the range of from about 0.1 to 250 micrometers, in some embodiments from about 0.5 to about 100 micrometers, in some embodiments from about 1 to about 50 micrometers, and in some embodiments, from about 2 to 30 micrometers. Regardless of their size, however, the fibers may exhibit excellent strength. One parameter that is indicative of the relative strength of the fibers is “tenacity”, which indicates the tensile strength of a fiber expressed as force per unit linear density. For example, the fibers of the present invention may have a tenacity of from about 5 to about 50 grams-force (“g_{f}”) per denier, in some embodiments from about 10 to about 40 g_{f} per denier, and in some embodiments, from about 15 to about 30 g_{f} per denier. The fibers may, for example, have a denier (i.e., the unit of linear density equal to the mass in grams per 9000 meters of fiber) of from about 50 to about 3000, in some embodiments from about 200 to 3000, and in some embodiments, from about 650 to about 2000. The elongation at break may also be relatively high, such as about 1.0% or more, in some embodiments about 1.5% or more, and in some embodiments, from about 2% to about 5%. The fibers are also relatively flexible, yet possess a sufficient degree of stiffness to be readily employed in various types of articles. The degree of stiffness is generally represented by the “tensile modulus” of the fibers, which refers to the ratio of uniaxial stress to strain. For example, the tensile modulus may range from about 20 to about 300 Gigapascals (“GPa”), in some embodiments from about 40 to about 200 GPa, and in some embodiments, from about 60 to about 180 GPa. The tenacity, elongation at break, and tensile modulus may be determined using a variety of techniques, one of which is described in ASTM D2256-10e1.

The fibers of the present invention may be employed in a wide variety of different articles and products, such as belts, hoses, composites, fiber optics, electromechanical materials, gaskets, brake pads, coverings, upholstery, clothing and other protective apparel, gloves, insulation, sleeves, ropes, barriers, blankets, masks, filtration systems, textiles, and so forth.

The present invention may be better understood with reference to the following examples.

### Test Methods

Melt Viscosity:

The melt viscosity (Pa-s) may be determined in accordance with ASTM Test No. 1238-70 (or ISO Test No. 11443) at a shear rate of 400 or 1000 s⁻¹ using a Dynisco LCR7001 capillary rheometer. The rheometer orifice (die) may have a diameter of 1 mm, length of 20 mm, LID ratio of 20.1, and an entrance angle of 180°. The diameter of the barrel was 9.55 mm t 0.005 mm and the length of the rod may be 233.4 mm. The melt viscosity may be determined at temperatures ranging from 280° C. to 370° C. depending on the melting temperature (e.g., 280° C., 340° C., 345° C., or 350° C.). For example, melt viscosity may be determined at a temperature of about 10° C. above the melting temperature.

Intrinsic Viscosity:

The intrinsic viscosity (“IV”) may be measured in accordance with ISO-1628-5 using a 50/50 (v/v) mixture of pentafluorophenol and hexafluoroisopropanol. Each sample may be prepared in duplicate by weighing about 0.02 grams into a 22 mL vial. 10 mL of pentafluorophenol (“PFP”) may be added to each vial and the solvent. The vials may be placed in a heating block set to 80° C. overnight. The following day 10 mL of hexafluoroisopropanol (“HFIP”) may be added to each vial, The final polymer concentration of each sample may be about 0.1%. The samples may be allowed to cool to room temperature and analyzed using a PolyVisc automatic viscometer.

Melting and Crystallization Temperatures:

The melting temperature (“Tm”) and crystallization temperature (“Tc”) were determined by differential scanning calorimetry (“DSC”) as is known in the art. The melting temperature is the differential scanning calorimetry (DSC) peak melt temperature as determined by ISO Test No. 11357. The crystallization temperature is determined from the cooling exotherm in the cooling cycle. Under the DSC procedure, samples were heated and cooled at 20° C. per minute as stated in ISO Standard 10350 using DSC measurements conducted on a TA Q2000 Instrument.

GPC Analysis:

To determine molecular weight, the samples may be dissolved in 50/50 HFIP/PFP to a concentration of 1.00 mg/ml and left on an orbital shaker for 24 hours. The samples may be filtered using 0.2 μm disposable Teflon filters. After filtration, the samples may be run in duplicate in the same solvent. The system may be run at a flow rate of 1.0 ml/min on a JORDI DVB Mixed Bed column, 250 mm×10 mm (ID). The column temperature may be maintained at 40° C. Injection size may be 50 μl of a 1.00 mg/ml sample solution. Polymethylmethacrylate standards with a concentration of 0.5 mg/ml may be used (molecular weight as follows: 903K, 701K, 366K, 110K, 89.3K, 31.6K, 14.7K, 5.09K, 2.58K, 402 & 202) with an injection size of 50 μl. The samples may be monitored at a sensitivity of 8 and a scale factor of 20 with a WATERS 410 differential refractometer. Data acquisition and handling may be performed with Jordi GPC software.

Tensile Properties:

The tensile properties of the fibers may be tested according to ASTM D2256. Modulus and strength measurements may be made on the same test sample which had a gage length of 10 inches. The testing temperature may be 23° C., and the testing speed may be 10 in/min.

### Synthesis of N1,N4-diphenylterephthalamide

### Compound A

The synthesis of Compound A from terephthaloyl chloride and aniline may be performed according to the following scheme:

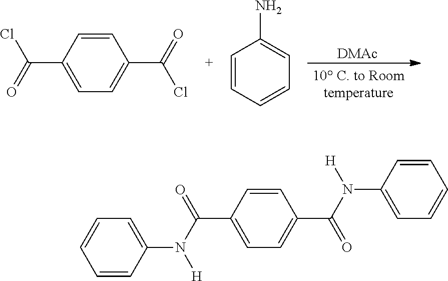

The experimental set up consisted of a 2 L glass beaker equipped with a glass rod stirrer coupled with an overhead mechanical stirrer. Dimethyl acetamide (“DMAc”) (3 L) was added to the beaker and the beaker was immersed in an ice bath to cool the system to 10-15° C. Then aniline (481.6 g) was added to the solvent with constant stirring, the resultant mixture was cooled to 10-15° C. Terephthaloyl chloride (300 g) was added gradually to the cooled stirred mixture such that the temperature of the reaction was maintained below 30° C. The acid chloride was added over a period of one-two hours, after which the mixture was stirred for another three hours at 10-15° C. and then at room temperature overnight. The reaction mixture was milky white (a fine suspension of the product in the solvent) and was vacuum filtered using a filter paper and a Buchner funnel. The crude product was washed with acetone (2 L) and then washed with hot water (2 L). The product was then air dried over night at room temperature and then was dried in a vacuum oven 150° C. for 4-6 hours. The product (464.2 g) was a highly crystalline white solid. The melting point was 346-348° C., as determined by differential scanning calorimetry (“DSC”).

### Synthesis of N1,N3-diphenylisophthalamide

### Compound B

The synthesis of Compound B from isophthaloyl chloride and aniline may be performed according to the following scheme:

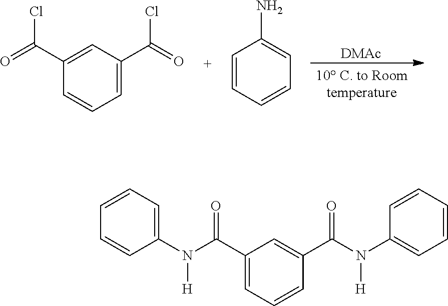

The experimental set up consisted of a 2 L glass beaker equipped with a glass rod stirrer coupled with an overhead mechanical stirrer. DMAc (1.5 L) was added to the beaker and the beaker was immersed in an ice bath to cool the solvent to 10-15° C. Then aniline (561.9 g) was added to the solvent with constant stirring, the resultant mixture was cooled to 10-15° C. Isophthaloyl chloride (350 g dissolved in 200 g of DMAc) was added gradually to the cooled stirred mixture such that the temperature of the reaction was maintained below 30° C. The acid chloride was added over a period of one hour, after which the mixture was stirred for another three hours at 10-15° C. and then at room temperature overnight. The reaction mixture was milky white in appearance. The product was recovered by precipitation by addition of 1.5 L of distilled water and followed by was vacuum filtration using a filter paper and a Buchner funnel. The crude product was then washed with acetone (2 L) and then washed again with hot water (2 L). The product was then air dried over night at room temperature and then was dried in a vacuum oven 150° C. for 4-6 hours. The product (522 g) was a white solid. The melting point was 290° C. as determined by DSC.

### Synthesis of N1,N4-bis(2,3,4,5,6-pentafluorophenyl)terephthalamide

### Compound C

The synthesis of Compound C from pentafluorophenol and terephthaloyl chloride may be performed according to the following scheme:

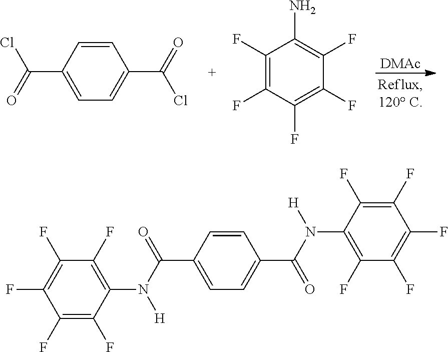

Pentafluoroaniline (10 g) was dissolved in dimethyl acetamide

(DMAc) (50 mL) and terephthaloyl chloride (3.7 g) was added in one portion. The reaction mixture was stirred and then refluxed for six (6) hours at 120° C. The reaction mixture was then cooled and 200 mL water was added to the mixture to precipitate the crude product. The product was then filtered and dried. The crude product was then washed with acetone (100 mL) and dried to give a white powder as the final product (6.8 g). The melting point by DSC was 331.6° C.

### Synthesis of N4-phenyl-N1-[4-[[4-(phenylcarbamoyl)benzoyl]amino]phenyl]terephthalamide

### Compound E

The synthesis of Compound E from 4-amino benzanilide and terephthaloyl chloride can be performed according to the following scheme:

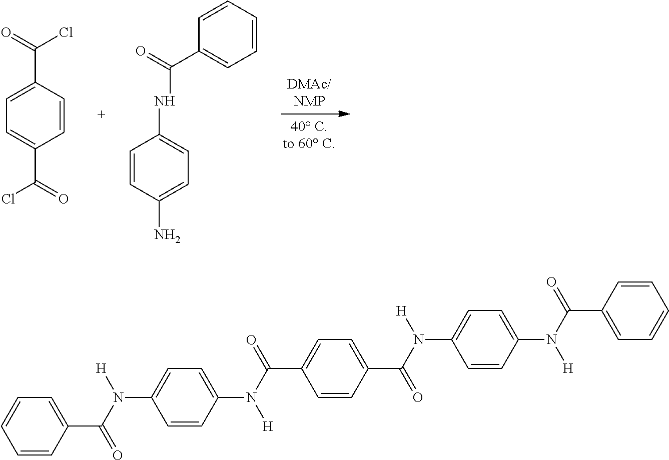 [SMILES: O=C(Cl)c1ccc(C(=O)Cl)cc1 ; Nc1ccc(NC(=O)c2ccccc2)cc1 ; O=C(Nc1ccc(NC(=O)c2ccc(C(=O)Nc3ccc(NC(=O)c4ccccc4)cc3)cc2)cc1)c1ccccc1]

The experimental setup consisted of a 1 L glass beaker equipped with a glass rod stirrer coupled with an overhead mechanical stirrer. 4-aminobenzanilide (20.9 g) was dissolved in warm DMAc (250 mL) (alternatively N-methylpyrrolidone can also be used). Terephthaloyl chloride (10 g) was added to the stirred solution of the diamine maintained at 40-50° C., upon the addition of the acid chloride the reaction temperature increased from 50° C. to 80° C. After the addition of the acid chloride was completed, the reaction mixture was warmed to 70-80° C. and maintained at that temperature for about three hours and allowed to rest overnight at room temperature. The product was then isolated by the addition of water (500 mL) followed by vacuum filtration followed by washing with hot water (1 L). The product was then dried in a vacuum oven at 150° C. for about 6-8 hours, to give a pale yellow colored solid (yield ca. 90%). The melting point by DSC was 462° C.

### Synthesis of N1,N3-bis(4-benzamidophenyl)benzene-1,3-dicarboxamide

### Compound F2

The synthesis of Compound F2 from 1,4-phenylene diamine, terephthaloyl chloride, and benzoyl chloride may be performed according to the following scheme:

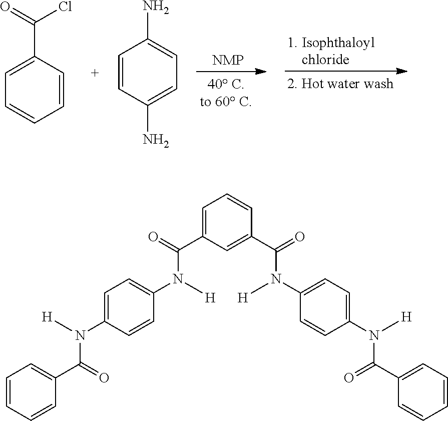 [SMILES: O=C(Cl)c1ccccc1 ; Nc1ccc(N)cc1 ; O=C(Nc1ccc(NC(=O)c2cccc(C(=O)Nc3ccc(NC(=O)c4ccccc4)cc3)c2)cc1)c1ccccc1]

The experimental setup consisted of a 500 mL glass beaker equipped with a magnetic stirrer. 1,4 phenylene diamine (20 g) was dissolved in warm NMP (200 mL) at 40° C. Benzoyl chloride (26.51 g) was added drop wise to a stirred solution of the diamine over a period of 30 minutes. After the addition of the benzoyl chloride was completed, the reaction mixture was warmed to 70-80° C. and then allowed to cool to 50° C. After cooling to the desired temperature, isophthaloyl chloride (18.39 g) was added in small portions such that the temperature of the reaction mixture did not increase above 70° C. The mixture was then stirred for additional one (1) hour at 70° C., and was allowed to rest overnight at room temperature. The product was recovered by addition of water (200 mL) to the reaction mixture, followed by filtration and washing with hot water (500 mL). The product was then dried in a vacuum oven at 150° C. for about 6-8 hours to give a pale yellow colored solid (51 g). The melting point by DSC was 329° C.

### Synthesis of N1,N3-bis(3-benzamidophenyl)benzene-1,3-dicarboxamide

### Compound G2

The synthesis of Compound G2 from 1,3-phenylene diamine, isophthaloyl chloride, and benzoyl chloride may be performed according to the following scheme:

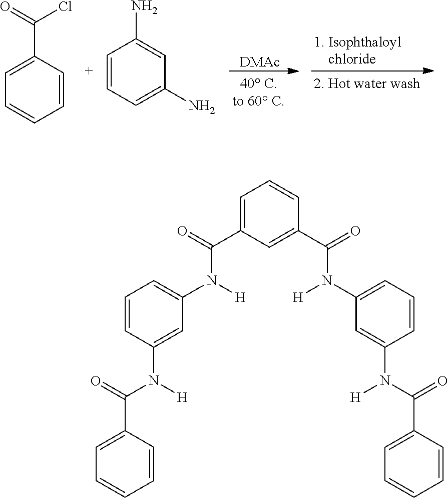

The experimental setup consisted of a 500 mL glass beaker equipped with a magnetic stirrer. 1,3 phenylene diamine (20 g) was dissolved in warm DMAc (200 mL) at 40° C. Benzoyl chloride (26.51 g) was added drop wise to a stirred solution of the diamine over a period of 30 minutes. After the addition of the benzoyl chloride was completed, the reaction mixture was warmed to 70-80° C. and allowed to cool to 50° C. After cooling to the desired temperature, isophthaloyl chloride (18.39 g) was added in small portions such that the temperature of the reaction mixture did not increase above 70° C. The mixture was then stirred for additional one hour at 70° C., and was allowed to rest overnight at room temperature. The product was recovered by addition of water (200 mL) to the reaction mixture, followed by filtration and washing with hot water (500 mL). The product was then dried in a vacuum oven at 150° C. for about 6-8 hours to give a pale yellow colored solid (45 g).

### Synthesis of N1,N3,N5-triphenylbenzene-1,3,5-tricarboxamide

### Compound J

Compound J was synthesized from trimesoyl chloride and aniline according to the following scheme:

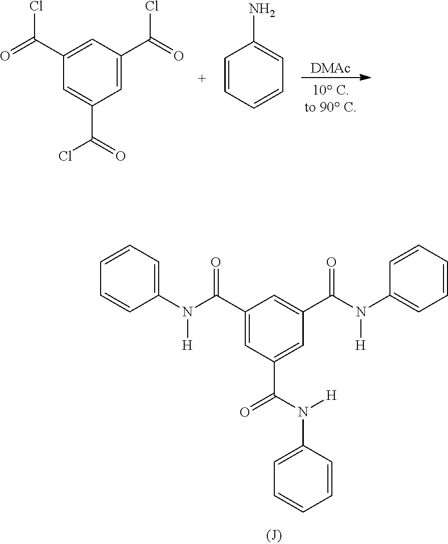

The experimental set up consisted of a 2 L glass beaker equipped with a glass rod stirrer coupled with an overhead mechanical stirrer. Trimesoyl chloride (200 g) was dissolved in dimethyl acetamide (“DMAc”) (1 L) and cooled by an ice bath to 10-20° C. Aniline (421 g) was added drop wise to a stirred solution of the acid chloride over a period of 1.5 to 2 hours. After the addition of the amine was completed, the reaction mixture was stirred additionally for 45 minutes, after which the temperature was increased to 90° C. for about 1 hour. The mixture was allowed to rest overnight at room temperature. The product was recovered by precipitation through the addition of 1.5 L of distilled water, which was followed by was vacuum filtration using a filter paper and a Buchner funnel. The crude product was washed with acetone (2 L) and then washed again with hot water (2 L). The product was then air dried over night at room temperature and then was dried in a vacuum oven 150° C. for 4 to 6 hours. The product (250 g) was a white solid, and had a melting point of 319.6° C., as determined by differential scanning calorimetry (“DSC”).

### Synthesis of N1,N3-dicyclohexyl-1,3-Benzenedicarboxamide

### Compound N1

The synthesis of Compound N1 from isophthaloyl chloride and cyclohexyl amine can be performed according to the following scheme:

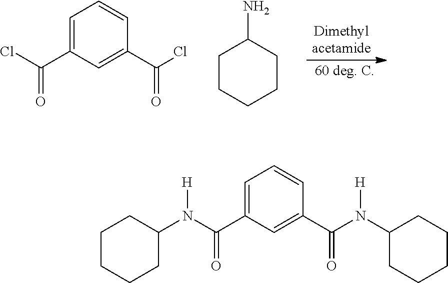

The experimental set up consisted of a 1 L glass beaker equipped with a glass rod stirrer coupled with an overhead mechanical stirrer. Cyclohexyl amine (306 g) was mixed in dimethyl acetamide (1 L) (alternatively N-methyl pyrrolidone can also be used) and triethyl amine (250 g) at room temperature. Next isopthaloyl chloride (250 g) was slowly added over a period of 1.5 to 2 hours, to the amine solution with constant stirring. The rate of addition of the acid chloride was maintained such that the reaction temperature was maintained less than 60° C. After complete addition of the benzoyl chloride, the reaction mixture was gradually warmed to 85-90° C. and then allowed to cool to around 45-50° C. The mixture was allowed to rest overnight (for at least 3 hours) at room temperature. The product was recovered by precipitation through the addition of 1.5 L of distilled water, which was followed by was vacuum filtration using a filter paper and a Buchner funnel. The crude product was then washed with acetone (250 mL) and washed again with hot water (500 mL). The product (yield: ca. 90%) was then air dried over night at room temperature and then was dried in a vacuum oven 150° C. for 4 to 6 hours. The product was a white solid. The Proton NMR characterization was as follows: ¹H NMR (400 MHz d₆-DMSO): 8.3 (s, 2H, CONH), 8.22 (s, 1H, Ar), 7.9 (d, 2H, Ar), 7.5 (s, 1H, Ar), 3.7 (broad s, 2H, cyclohexyl), 1.95-1.74 broad s, 4H, cyclohexyl) and 1.34-1.14 (m, 6H, cyclohexyl).

### Example 1

A two-liter, three-neck flask was charged with 4-hydroxybenzoic acid (562.0 g, 4.07 moles), 2,6-hydroxynaphthoic acid (61.2 g, 0.52 moles), terephthalic acid (174.9 g, 1.05 moles), 4,4′-biphenol (135.6 g, 0.73 moles), acetaminophen (49.1 g, 0.32 moles), potassium acetate (43 mg, 0.44 mmoles), and Compound A (17 g, 0.054 moles). The flask next was equipped with C-shaped stirrer, a thermal couple, a gas inlet, and distillation head. The flask was placed under a low nitrogen purge and acetic anhydride (99.7% assay, 651.9 g) was added. The milky-white slurry was agitated at 75 rpm and heated to 140° C. over the course of 95 minutes using a fluidized sand bath. After this time, the mixture was then gradually heated to 350° C. steadily over 290 minutes. Reflux was seen once the reaction exceeded 140° C. and the overhead temperature increased to approximately 115° C. as acetic acid byproduct (760 g) was removed from the system. During the heating, the mixture became yellow and slightly more viscous and the vapor temperature gradually dropped to 90° C. Once the mixture had reached 350° C., the nitrogen flow was stopped. The flask was evacuated below 20 psi and the agitation slowed to 30 rpm over the course of 45 minutes. After 102 minutes, the reaction was then stopped by releasing the vacuum and stopping the heat flow to the reactor—no torque reading was recorded. The flask was cooled and then polymer was recovered as a solid, dense yellow-brown plug. Sample for analytical testing was obtained by mechanical size reduction. Yield=821.39 g.

The samples of the aforementioned examples were then tested for thermal properties. The results are set forth below.

| Comp. | Ex. 1 |
|---|---|
| Oligomer | A |
| Melt Viscosity | 6.2 |
| (1000 s⁻¹) (Pa-s) | |
| Melt Viscosity | 8.2 |
| (400 s⁻¹) (Pa-s) | |
| Intrinsic Visc. | 4.0 |
| (dL/g) | |
| Tm (° C.) | 328.26 |
| Tc (° C.) | 281.97 |
| Mₙ (g/mol) | 6,777 |
| M_{w} (g/mol) | 27,428 |
| Peak Molecular | 22,451 |
| Weight (g/mol) | |

### Example 2

Various polymers (Samples 1-6) are formed as described in Example 1. Samples 1 and 4 contain Compound A in an amount of 2 wt. % and 3 wt. %, respectively. Neither of these samples is solid-state polymerized. Samples 2 and 3 contain Compound A in an amount of 2 wt % and are both solid state polymerized by heating to greater than 250° C. while tumbling in an oil-heated drying oven until the desired melt viscosity (at 340° C. or 350° C.) is reached. Sample 3 is solid-state polymerized for a longer period of time than Sample 2. Samples 5 and 6 contain Compound A in an amount of 3 wt. % and are solid-state polymerized as described above until the desired melt viscosity (at 345° C. or 350° C.) is reached. Sample 6 is solid-state polymerized for a longer period of time than Sample 5. A control sample is also formed that does not contain Compound A and is not solid state-polymerized.

The thermal properties of the polymers are tested as described above. The results are set forth below.

| | | | | | MV at | MV at |
|---|---|---|---|---|---|---|
| | Compound A | | | | 400 s⁻¹ at | 1,000 s⁻¹ at |
| Sample | (wt. %) | Tm (° C.) | Tc (° C.) | T1 (° C.) | T1 (Pa-s) | T1 (Pa-s) |
| Control | 0 | 335.15 | 276.28 | 340 | 112.2 | 69.7 |
| 1 | 2 | 329.75 | 272.75 | 340 | 116.1 | 73.1 |
| 2 | 2 | 331.69 | 269.40 | 340 | 427.0 | 220.0 |
| 3 | 2 | 336.02 | 267.09 | 350 | 864.3 | 440.5 |
| 4 | 3 | 327.50 | 269.93 | 340 | 149.6 | 86.8 |
| 5 | 3 | 334.81 | 268.68 | 345 | 497.3 | 239.4 |
| 6 | 3 | 338.72 | 262.66 | 350 | 734.7 | 373.0 |

Monofilaments may also be formed as described herein and shown in FIG. 1. More particularly, dried pellets may be stored in an extruder feed hopper and supplied to an extruder, which melts the pellets and feeds them to a spinning head via a melt transfer line. The spinning head may have a metering pump and spinneret-assembly. The spinneret assembly may have a shattered-metal/sand, filter screens, distributor plate, and spinneret. A heated shroud (2-7″ length with temperature from 200° to 350° C.) may also be used to increase the spin draft. Filaments may be extruded through this system and then cooled in a quench chamber. The filaments may be collected in a package by a gadget and winder system (speed of 100 to 1000 m/min).

### Example 3

A two-liter, three-neck flask was charged with 4-hydroxybenzoic acid (338.4 g, 2.45 moles), terephthalic acid (186 g, 1.12 moles), isophthalic acid (192 g, 1.16 moles), 4,4′-biphenol (209 g, 1.12 moles), hydroquinone (127 g, 1.16 moles), potassium acetate (70 mg). The flask next was equipped with C-shaped stirrer, a thermal couple, a gas inlet, and distillation head. The flask was placed under a low nitrogen purge and acetic anhydride (99.7% assay, 735 g) was added. The milky-white slurry was agitated at 75 rpm and heated to 140° C. over the course of 95 minutes using a fluidized sand bath. After this time, the mixture was then gradually heated to 320° C. steadily over 260 minutes, Reflux was seen once the reaction exceeded 140° C. and the overhead temperature increased to approximately 115° C. as acetic acid byproduct (831 g) was removed from the system. During the heating, the mixture became yellow and slightly more viscous and the vapor temperature gradually dropped to 90° C. Once the mixture had reached 320° C., the nitrogen flow was stopped. The flask was evacuated below 20 psi and the agitation slowed to 30 rpm over the course of 45 minutes. After 155 minutes, the reaction was then stopped by releasing the vacuum and stopping the heat flow to the reactor. The flask was cooled and then polymer was recovered as a solid, dense yellow-brown plug. Sample for analytical testing was obtained by mechanical size reduction. Yield=881 g.

The samples of Example 3 were then tested for thermal properties. The results are set forth below.

| Comp. | Ex. 3 |
|---|---|
| Melt Viscosity | 6.2 |
| (1000 s⁻¹⁾ (Pa-s) at 280° C. | |
| Melt Viscosity | 12 |
| (400 s⁻¹⁾ (Pa-s) at 280° C. | |
| Tm (° C.) | 263 |
| Tc (° C.) | 216 |

A variant of Example 3 may also be prepared by adding 23.1 g of Compound A to the reaction mixture of Example 3. Another variant of Example 3 may be prepared by adding 23.1 g of Compound B to the reaction mixture of Example 3.

### Example 4

A two-liter, three-neck flask was charged with 4-hydroxybenzoic acid (510 g, 3.69 moles). 2,6-napthalene dicarboxylic acid (31 g, 0.14 moles), terephthalic acid (168 g, 1.01 moles), 4,4′-biphenol (107 g, 0.58 moles), hydroquinone (63.5 g, 0.58 moles), potassium acetate (41 mg), and Compound A (23.15 g). The flask next was equipped with C-shaped stirrer, a thermal couple, a gas inlet, and distillation head. The flask was placed under a low nitrogen purge and acetic anhydride (99.7% assay, 630 g) was added. The milky-white slurry was agitated at 75 rpm and heated to 140° C. over the course of 95 minutes using a fluidized sand bath. After this time, the mixture was then gradually heated to 360° C. steadily over 300 minutes. Reflux was seen once the reaction exceeded 140° C. and the overhead temperature increased to approximately 115° C. as acetic acid byproduct (680 g) was removed from the system. During the heating, the mixture became yellow and slightly more viscous and the vapor temperature gradually dropped to 90° C. Once the mixture had reached 360° C., the nitrogen flow was stopped. The flask was evacuated below 20 psi and the agitation slowed to 30 rpm over the course of 45 minutes. After 60 minutes, the reaction was then stopped by releasing the vacuum and stopping the heat flow to the reactor—no torque reading was recorded. The flask was cooled and then polymer was recovered as a solid, dense yellow-brown plug. Sample for analytical testing was obtained by mechanical size reduction. Yield=783 g.

The samples of the aforementioned example 4 were then tested for thermal properties. The results are set forth below.

| Comp. | Ex. 4 |
|---|---|
| Oligomer | A |
| Melt Viscosity | 2 |
| (1000 s⁻¹⁾ (Pa-s) at 360 deg. C. | |
| Melt Viscosity | 3.3 |
| (400 s⁻¹⁾ (Pa-s) at 360 deg. C. | |
| Tm (° C.) | 342 |
| Tc (° C.) | 305 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A fiber that is formed from a polymer composition, wherein the polymer composition comprises a thermotropic liquid crystalline polymer and an aromatic amide oligomer in an amount of from about 0.1 to about 8 parts by weight relative to 100 parts by weight of the liquid crystalline polymer.

2. The fiber of claim 1, wherein aromatic amide oligomers constitute from about 0.1 wt. % to about 8 wt. % of the polymer composition.

3. The fiber of claim 1, wherein liquid crystalline polymers constitute from about 92 wt. % to about 99.9 wt. % of the polymer composition.

4. The fiber of claim 1, wherein the aromatic amide oligomer has a molecular weight of about 1,000 grams per mole or less.

5. The fiber of claim 1, wherein the oligomer has the following general formula (I): 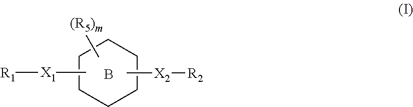
wherein,
ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;
R₅ is halo, haloalkyl, alkyl, alkenyl, aryl, heteroaryl, cycloalkyl, or heterocyclyl;
m is from 0 to 4;
X₁ and X₂ are independently C(O)HN or NHC(O); and
R₁ and R₂ are independently selected from aryl, heteroaryl, cycloalkyl, and heterocyclyl.

6. The fiber of claim 5, wherein ring B is phenyl, R₁ is phenyl or cyclohexyl, and R₂ is phenyl or cyclohexyl.

7. The fiber of claim 1, wherein the aromatic amide oligomer has the following general formula (IV): 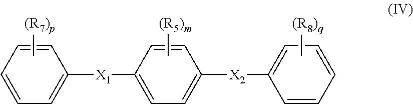
wherein,
X₁ and X₂ are independently C(O)HN or NHC(O);
R₅, R₇, and R₈ are independently selected from halo, haloalkyl, alkyl, alkenyl, aryl, heteroaryl, cycloalkyl, and heterocyclyl;
m is from 0 to 4; and
p and q are independently from 0 to 5.

8. The fiber of claim 1, wherein the aromatic amide oligomer is selected from the group consisting of the following compounds:

| Structure | Name |
|---|---|
| 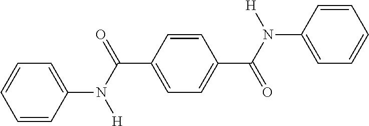 [SMILES: O=C(Nc1ccccc1)c1ccc(C(=O)Nc2ccccc2)cc1] | N1,N4-diphenylterephthalamide |
| 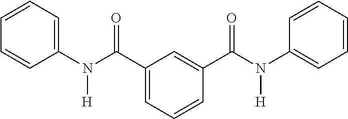 [SMILES: O=C(Nc1ccccc1)c1cccc(C(=O)Nc2ccccc2)c1] | N1,N4-diphenylisophthalamide |
| 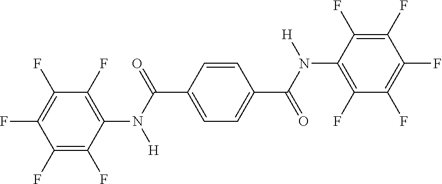 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6-pentafluorophenyl)- terephthalamide |
| 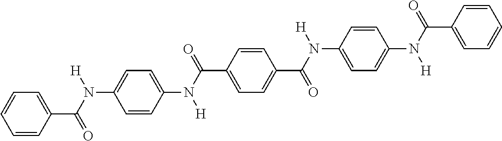 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzamidophenyl)terephthalamide |
| 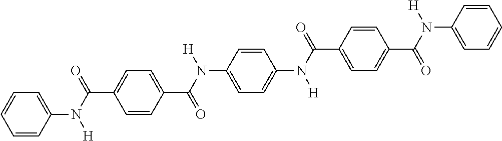 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1-[4-[[4- (phenylcarbamoyl)benzoyl]amino]phenyl] terephthalamide |
| 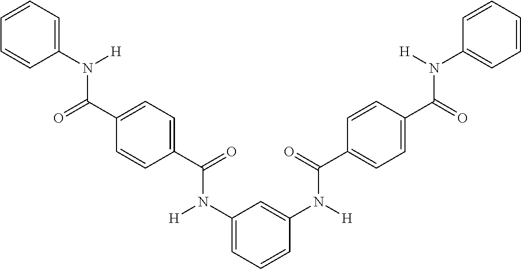 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl)benzoyl]amino]phenyl] terephthalamide |
| 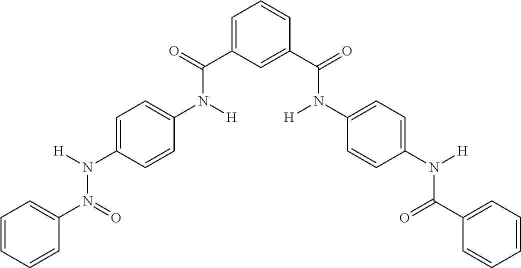 | N1,N3-bis(4-benzamidophenyl)benzene- 1,3-dicarboxamide |
| 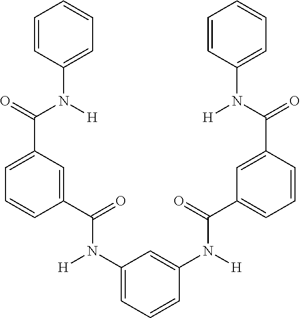 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl)benzoyl]amino]phenyl] benzene-1,3-dicarboxamide |
| 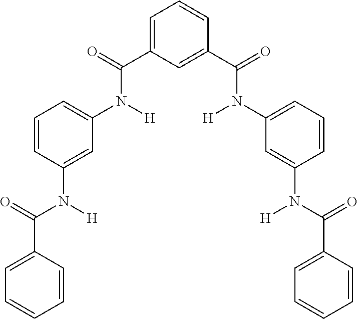 [SMILES: O=C(Nc1cccc(NC(=O)c2cccc(C(=O)Nc3cccc(NC(=O)c4ccccc4)c3)c2)c1)c1ccccc1] | N1,N3-bis(3-benzamidophenyl)benzene- 1,3-dicarboxamide |
| 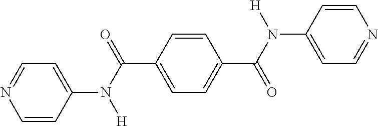 [SMILES: O=C(Nc1ccncc1)c1ccc(C(=O)Nc2ccncc2)cc1] | N1,N4-bis(4-pyridyl)terephthalamide |
| 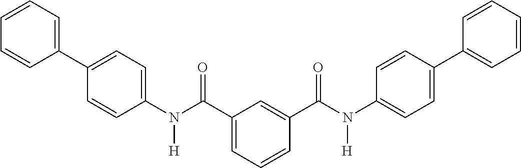 [SMILES: O=C(Nc1ccc(-c2ccccc2)cc1)c1cccc(C(=O)Nc2ccc(-c3ccccc3)cc2)c1] | N1,N3-bis(4-phenylphenyl)benzene-1,3- dicarboxamide |
| 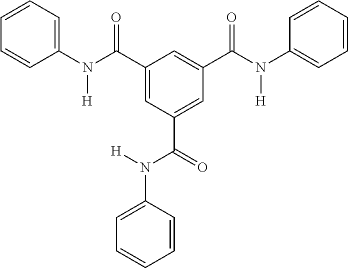 [SMILES: O=C(Nc1ccccc1)c1cc(C(=O)Nc2ccccc2)cc(C(=O)Nc2ccccc2)c1] | N1,N3,N5-triphenylbenzene-1,3,5- tricarboxamide |
| 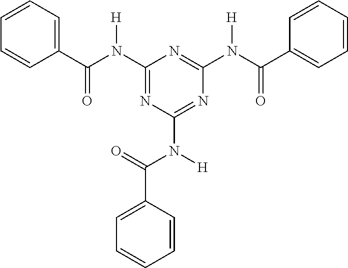 [SMILES: O=C(Nc1nc(NC(=O)c2ccccc2)nc(NC(=O)c2ccccc2)n1)c1ccccc1] | N-(4,6-dibenzamido-1,3,5-triazin-2- yl)benzamide |
| 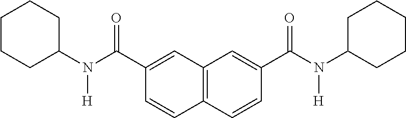 [SMILES: O=C(NC1CCCCC1)c1ccc2ccc(C(=O)NC3CCCCC3)cc2c1] | N2,N7-dicyclohexylnaphthalene-2,7- dicarboxamide |
| 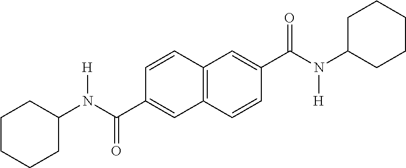 [SMILES: O=C(NC1CCCCC1)c1ccc2cc(C(=O)NC3CCCCC3)ccc2c1] | N2,N6-dicyclohexylnaphthalene-2,6- dicarboxamide |
| 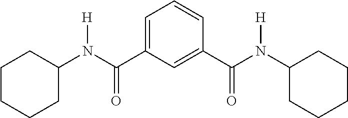 [SMILES: O=C(NC1CCCCC1)c1cccc(C(=O)NC2CCCCC2)c1] | N1,N3-dicyclohexyl-1,3- Benzenedicarboxamide |
| 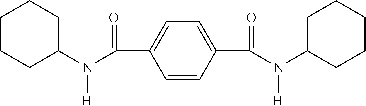 [SMILES: O=C(NC1CCCCC1)c1ccc(C(=O)NC2CCCCC2)cc1] | N1,N4-dicyclohexyl-1,4- Benzenedicarboxamide |
| 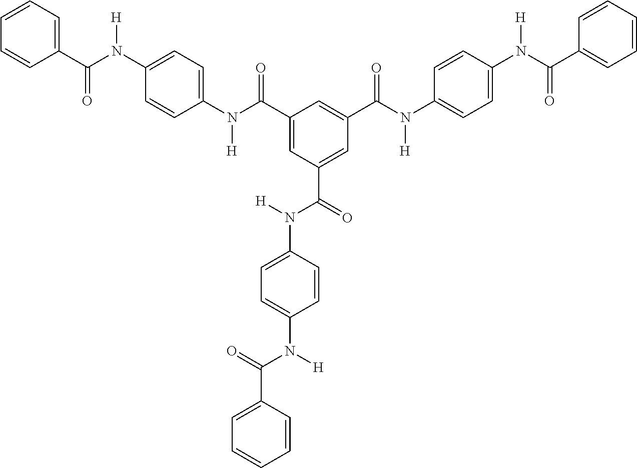 [SMILES: O=C(Nc1ccc(NC(=O)c2cc(C(=O)Nc3ccc(NC(=O)c4ccccc4)cc3)cc(C(=O)Nc3ccc(NC(=O)c4ccccc4)cc3)c2)cc1)c1ccccc1] | N1,N3,N5-tris(4- benzamidophenyl)benzene-1,3,5- tricarboxamide |
| 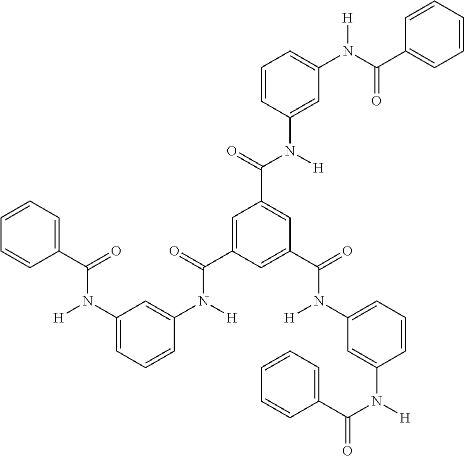 [SMILES: O=C(Nc1cccc(NC(=O)c2cc(C(=O)Nc3cccc(NC(=O)c4ccccc4)c3)cc(C(=O)Nc3cccc(NC(=O)c4ccccc4)c3)c2)c1)c1ccccc1] | N1,N3,N5-tris(3- benzamidophenyl)benzene-1,3,5- tricarboxamide |

9. The fiber of claim 1, wherein the aromatic amide oligomer is N1,N4-diphenylterephthalamide, N1,N3-diphenylisophthalamide, N1,N3-dicyclohexyl-1,3-benzenedicarboxamide, or N1,N4-dicyclohexyl-1,4-benzenedicarboxamide.

10. The fiber of claim 1, wherein the liquid crystalline polymer contains from about 50 mol. % to about 99 mol. % of aromatic ester repeating units derived from an aromatic dicarboxylic acid, an aromatic hydroxycarboxylic acid, or a combination thereof.

11. The fiber of claim 10, wherein the aromatic dicarboxylic acid includes terephthalic acid, isophthalic acid, 2,6-naphthalenedicarboxylic acid, or a combination thereof, and wherein the aromatic hydroxycarboxylic acid includes 4-hydroxybenzoic acid, 2-hydroxy-6-naphthoic acid, or a combination thereof.

12. The fiber of claim 10, wherein the liquid crystalline polymer further comprises one or more repeating units derived from an aromatic dial, aromatic amide, aromatic amine, or a combination thereof.

13. The fiber of claim 1, wherein the polymer composition has a melting temperature of from about 250° C. to about 400° C. and a crystallization temperature of from about 200° C. to about 300° C.

14. The fiber of claim 1, wherein the polymer composition has a melt viscosity of about 50 Pa-s or more, as determined in accordance with ASTM Test No. 1238-70 at a shear rate of 1000 seconds⁻¹ and temperature 10° C. above the melting temperature of the polymer composition.

15. The fiber of claim 1, wherein the fiber has an average diameter in the range of from about 0.1 to 250 micrometers.

16. The fiber of claim 1, wherein the fiber has a tenacity of from about 5 to about 50 grams-force per denier.

17. A method for forming a fiber, the method comprising:
extruding a polymer composition through a spinneret to form an elongate body, wherein the polymer composition comprises a thermotropic liquid crystalline polymer and an aromatic amide oligomer in an amount of from about 0.1 to about 8 parts by weight relative to 100 parts by weight of the liquid crystalline polymer; and
quenching the elongate body to form a fiber.

18. The method of claim 17, wherein the oligomer has the following general formula (I): 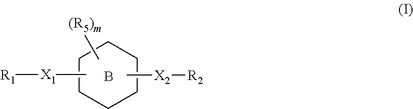
wherein,
ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;
R₅ is halo, haloalkyl, alkyl, alkenyl, aryl, heteroaryl, cycloalkyl, or heterocyclyl;
m is from 0 to 4;
X₁ and X₂ are independently C(O)HN or NHC(O); and
R₁ and R₂ are independently selected from aryl, heteroaryl, cycloalkyl, and heterocyclyl.

19. The method of claim 17, wherein the liquid crystalline polymer is formed by a method that includes melt polymerizing two or more monomers in the presence of the aromatic amide oligomer to form a melt-polymerized polymer.

20. The method of claim 19, wherein the method for forming the liquid crystalline polymer further comprises solid-state polymerizing the melt-polymerized polymer.

21. The method of claim 17, wherein the fiber is not subjected to heat treatment after being quenched.

22. The method of claim 17, further comprising passing the elongate body through a heated shroud prior to quenching.

23. The method of claim 22, further comprising drawing the elongate body.
